(19) United States
(12) Patent Application Publication
(10) Pub. No.: US 2009/0272721 A1
(43) Pub. Date: Nov. 5, 2009

(54) Athmosphere-Controlled Bonding Apparatus, Bonding Method, and Electronic Device

(75) Inventors: Tadahiro Ohmi, Miyagi (JP); Akihiro Morimoto, Miyagi (JP)

Correspondence Address: FOLEY AND LARDNER LLP;SUITE 500, 3000 K STREET NW, WASHINGTON, DC, 20007, US

(73) Assignee: Tadahiro OHMI

(21) Appl. No.: 11/992,667

(22) PCT Filed: Sep. 28, 2005
(86) PCT No.: PCT/JP2005/017803

§ 371 Date: Mar. 27, 2008

(51) Int. Cl. B23K 11/16; B23K 11/00

(52) U.S. Cl. 219/118; 219/78.01

(57) ABSTRACT

In a bonding apparatus for bonding under pressure a pressure-bonding portion, the concentration of water in a pressure-bonding portion atmosphere inside the apparatus is set smaller than that in an atmosphere outside the apparatus, thereby enabling pressure bonding under low-temperature and low-pressure conditions. In this case, the amount of adsorbed water on each surface of a bonding metal terminal and a to-be-bonded metal terminal forming the pressure-bonding portion is set to 1×10¹⁶ molecules/cm² or less.

### TECHNICAL FIELD

This invention relates to a bonding apparatus that is always used in manufacturing an electronic device and, in particular, mounting it. More specifically, this invention relates to a bonding apparatus and a bonding method for use in bonding such as wire bonding or flip-chip bonding for electrically connecting terminals on an electronic element such as a semiconductor chip to externally leading terminals and for use in electrically bonding under pressure metal terminals to each other when mounting an electronic element such as a semiconductor element or a capacitor on a mounting board such as a printed wiring board or a package board. Such a bonding method includes mounting onto an FPC (Flexible Printed Circuit) and it includes TAB (Tape Automated Bonding), wire bonding, wireless bonding such as flip-chip bonding, or the like.

### BACKGROUND ART

In recent years, following the development for miniaturization, higher functionality, and higher performance of electronic devices such as portable telephones, portable information terminals, and digital video terminals, there have also been strong demands for higher functionality, miniaturization, and lighter weight of printed wiring boards for use in mounting thereon semiconductor packages or electronic elements. The design requirement for printed boards is also shifting from conventional 50 to 100 μm design rules to future design rules of 10 μm or less and thus the requirement of miniaturization is increasing. In accordance therewith, the size of terminals for electrical connection between an element and a printed board is reduced and, further, the pitch of the terminals is narrowed. Consequently, there is demanded a bonding method with high electrical characteristics and high reliability. Further, electrical connection between a chip and externally leading terminals in a package of a device is also highly miniaturized and thus, also there, a bonding method with high electrical characteristics and high reliability is demanded. Such bonding is generally pressure bonding between metal terminals (including solder bumps etc.). However, the conventional pressure bonding is performed at a high temperature of several hundred ° C. and at a high pressure of several tons per cm², for example, in flip-chip bonding or wire bonding. Under such high-temperature and high-pressure conditions, oxygen and water in the atmosphere easily react with a terminal metal, a resin being a board material, and so on to cause degradation of the metal material due to oxidation, decomposition/dissociation of the resin, and so on, so that there have arisen a problem of a reduction in reliability due to degradation in electrical characteristics of bonding portions and lowering of the mechanical strength thereof and a problem of contamination due to decomposed organic substances.

As a method of suppressing oxidation degradation during bonding, there is a technique of suppressing oxidation degradation by setting a process atmosphere to an inert gas atmosphere, as exemplified by a wire bonding apparatus described in Patent Document 1 and so on.

Even in the bonding apparatus employing the above technique, there arises a problem that the bonding properties are not stable immediately after starting up the apparatus or a problem that the bonding properties are suddenly degraded, so that there is no alternative but to increase the pressure-bonding pressure or the pressure-bonding temperature in order to reliably form the bonding in a short time. If the pressure-bonding pressure is raised, there arises a problem of deformation of a resin forming a board, while, if the pressure-bonding temperature is raised, there arises a problem of degradation of the resin.

As a result of the repetition of assiduous studies by the inventors of this invention, it has become clear that it is necessary to fully remove adsorbed water and organic substances on the surfaces of a bonding portion at the time of bonding for the purpose of achieving a reduction in bonding temperature and pressure and an increase in bonding strength. For this purpose, it is important to reduce water and organic substances in a bonding portion atmosphere. It is also necessary to force out the water on the surfaces of the bonding portion by raising the temperature of the bonding portion to some degree. Further, it has become clear that it is necessary to remove water and organic contaminants on the inner surface of an apparatus serving as a flow path of an atmospheric dry gas and further to cause the inner surface thereof to be an inert surface that makes it difficult for water to adsorb thereon. It is also effective to reduce the concentration of oxygen contained in the atmosphere. Use is made of an inert gas atmosphere containing water and oxygen each in an amount of 10 vol.ppm or less, preferably 1 ppm or less, and more preferably 0.1 ppm or less. Hydrogen may be contained at an explosion limit of 4% or less. This makes it possible to reduce the pressure-bonding pressure and, as a result, to prevent degradation of the properties of an element. However, in such a dry atmosphere, static electricity is generated to cause breakage of the element. For preventing this, it is preferable to provide static electricity removal means. An ionizer, soft X-ray irradiation, a-ray electricity removal, or the like can be suitably used for removing the static electricity, wherein the soft X-ray irradiation is more preferable.

It is considered to apply the technique described in Patent Document 1 to a solder bump bonding apparatus or the like to thereby suppress oxidation degradation. However, according to the technique of Patent Document 1, it is described only to conduct an inert gas to a bonding processing portion, but there is no description about the amount of water or the amount of organic substances contained in the gas or about an apparatus structure for reducing the amount of water or the amount of organic substances contained in the gas. Since adsorption of water on the surfaces of metal terminals impedes adhesion between the terminals, the temperature/pressure of pressure bonding should be raised.
Patent Document 1: Japanese Unexamined Patent Application Publication (JP-A) No. Hei 5-109793

### DISCLOSURE OF THE INVENTION

### Problem to be Solved by the Invention

It is therefore an object of this invention to provide an electronic device manufacturing bonding apparatus and method capable of pressure bonding under low-temperature and low-pressure conditions, which can achieve high performance and high reliability without causing deterioration of an electrical bonding portion of an electronic device due to oxidation degradation or the like.

It is still another object of this invention to provide an electronic device manufactured using the above bonding method.

### Means for Solving the Problem

A bonding apparatus of this invention is a bonding apparatus for bonding under pressure a bonding metal terminal and a to-be-bonded metal terminal to each other and is characterized in that a water concentration in an atmosphere in a pressure-bonding portion is set smaller than that in an atmosphere outside the apparatus, and it is characterized in that an adsorbed water amount and an adsorbed organic substance amount on each of a surface of the bonding metal terminal and a surface of the to-be-bonded metal terminal in the pressure-bonding portion are 1×10¹⁶ molecules/cm² or less and 5×10¹³ molecules/cm² (in terms of eicosane) or less, respectively. Further, the bonding apparatus of this invention is characterized in that an inert gas is circulated to at least the pressure-bonding portion and it is characterized in that the bonding apparatus has a supply port for supplying the inert gas from the outside of the apparatus and a water content in the inert gas at the supply port is 10 vol.ppm or less. Further, it is characterized in that an adsorbed water amount and an adsorbed organic substance amount on a main inner surface of the apparatus where the inert gas is brought into contact are 1×10¹⁶ molecules/cm² or less and 5×10¹³ molecules/cm² (in terms of eicosane) or less, respectively. As the main inner surface forming the apparatus, there is cited an electrolytically polished stainless surface, an electrochemically polished stainless surface, an electrolytically or electrochemically polished surface containing chromium oxide as a main component, an electrolytically or electrochemically polished surface containing aluminum oxide as a main component, a polyolefin-based resin surface, a polycycloolefin-based resin surface, or a fluorine-based resin surface. In the bonding apparatus of this invention, the inert gas is characterized by containing at least one of nitrogen, helium, neon, argon, krypton, and xenon.

Further, the bonding apparatus of this invention is characterized by comprising a mechanism for reducing the adsorbed water amount on the surface of the bonding metal terminal and the surface of the to-be-bonded metal terminal to 1×10¹⁶ molecules/cm² or less and a mechanism for reducing the adsorbed organic substance amount thereon to 5×10¹³ molecules/cm² or less.

The bonding apparatus of this invention is characterized by comprising a mechanism for neutralizing static electricity generated in the apparatus at any of the bonding metal terminal, the to-be-bonded metal terminal, and the neighborhood therearound or at all of them. It is preferable to use an ionizer, α-rays, or soft X-rays for neutralizing the static electricity, wherein use of the soft X-rays is more preferable.

A metal terminal bonding method of this invention is a bonding method for electrically bonding under pressure a bonding metal terminal and a to-be-bonded metal terminal to each other, wherein a surface of the bonding metal terminal and a surface of the to-be-bonded metal terminal each contain at least one of lead, tin, silver, gold, copper, zinc, aluminum, bismuth, indium, and nickel, and bonding is formed in a pressure-bonding portion after reducing water and organic substances adsorbed on surfaces, adapted to form the bonding, to 1×10¹⁶ molecules/cm² or less and 5×10¹³ molecules/cm² (in terms of eicosane) or less, respectively.

The amount of adsorbed water and the amount of adsorbed organic substances on each of the surface of the bonding metal terminal and the surface of the to-be-bonded metal terminal at the pressure-bonding portion are preferably 1×10¹⁶ molecules/cm² or less and 5×10¹³ molecules/cm² (in terms of eicosane) or less, respectively, wherein single-molecular-layer adsorption is more preferable. This will be explained using FIG. 1. FIG. 1(a) is a diagram showing the bonding properties obtained when the bonding was formed by controlling the amount of adsorbed water on an aluminum surface and a gold surface, wherein plotting is performed with normalization by a bonding strength obtained when the water adsorption amount was 1×10¹⁴ molecules/cm². The control of the adsorbed water amount was performed by experimentally deriving, in advance, the relationship between the atmospheric water concentration and the adsorbed water amount using the same surfaces as the objective surfaces and by controlling the water concentration in an atmosphere. From FIG. 1, it is seen that the bonding properties start to degrade from 2×10¹⁵ molecules/cm² where the adsorbed water amount on the surfaces forming the bonding changes from single-molecular-layer adsorption to multi-molecular-layer adsorption and, after the adsorbed water amount exceeds 1×10¹⁶ molecules/cm², the bonding properties significantly degrade. This tendency was also the same between metal materials other than the above.

Likewise, FIG. 1(b) shows the relationship with respect to the amount of adsorbed organic substances.

Accordingly, the amount of adsorbed water and the amount of adsorbed organic substances on each of the surface of the bonding metal terminal and the surface of the to-be-bonded metal terminal are preferably 1×10¹⁶ molecules/cm² or less and 5×10¹³ molecules/cm² or less, respectively, wherein the single-molecular-layer adsorption is more preferable. For realizing such a water adsorption amount, it is possible to reduce the adsorbed water amount by circulating an inert gas to the pressure-bonding portion. The water content in the inert gas to be supplied is preferably 10 vol.ppm or less. In this case, it has been made clear by experiments that the water adsorption amount on the bonding surfaces becomes 1×10¹⁶ molecules/cm². If water is adsorbed on the inner surface of the apparatus where the inert gas is brought into contact, it takes a long time to remove the water adsorbed in the apparatus when starting up the apparatus or the adsorbed water is desorbed so as to be adsorbed on the bonding surfaces to deteriorate the bonding properties. Therefore, the amount of adsorbed water on the inner surface of the apparatus where the inert gas is brought into contact is preferably 1×10¹⁶ molecules/cm² or less, wherein a single molecular layer or less is more preferable. The main inner surface forming the apparatus is preferably an electrolytically polished stainless surface, an electrochemically polished stainless surface, an electrolytically or electrochemically polished surface containing chromium oxide as a main component, an electrolytically or electrochemically polished surface containing aluminum oxide as a main component, a polyolefin-based resin surface, a polycycloolefin-based resin surface, or a fluorine-based resin surface because its water adsorption amount is small. In the bonding apparatus of this invention, the inert gas may be nitrogen, helium, neon, argon, krypton, xenon, or the like, or may be a mixture thereof. In terms of suppressing oxidation of the bonding portion, hydrogen is preferably mixed in an amount of 0.1% or more and 4% or less.

This invention is suitably applicable to a flip-chip bonder, a wire bonder, or the like adapted to form pressure bonding. Ultrasonic wave or the like may used jointly.

### EFFECT OF THE INVENTION

In a bonding apparatus and a bonding method of this invention, the concentration of water in a bonding portion atmosphere is smaller than that in an atmosphere outside the apparatus and, therefore, a reduction in bonding temperature and a reduction is bonding pressure can be achieved without degrading the bonding strength. This makes it possible to form bonding while suppressing degradation in electrical characteristics of an element and thermal degradation and deformation of a resin. Further, in the bonding of this invention, since a static electricity neutralization apparatus using soft X-rays is employed, it is possible to suppress breakage of a product due to static electricity.

### BRIEF DESCRIPTION OF THE DRAWINGS

FIG. 1 shows the bonding properties obtained when the bonding was formed by controlling the amount of adsorbed water and the amount of adsorbed organic substances on an aluminum surface and a gold surface.

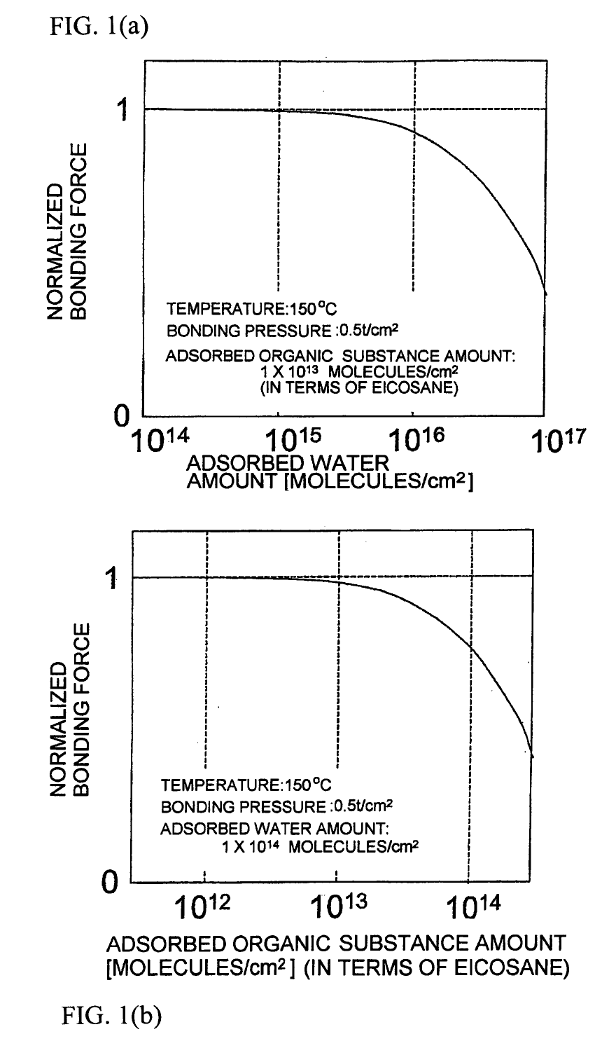

FIG. 2 is a schematic diagram showing a bonding apparatus according to an embodiment of this invention.

### BEST MODE FOR CARRYING OUT THE INVENTION

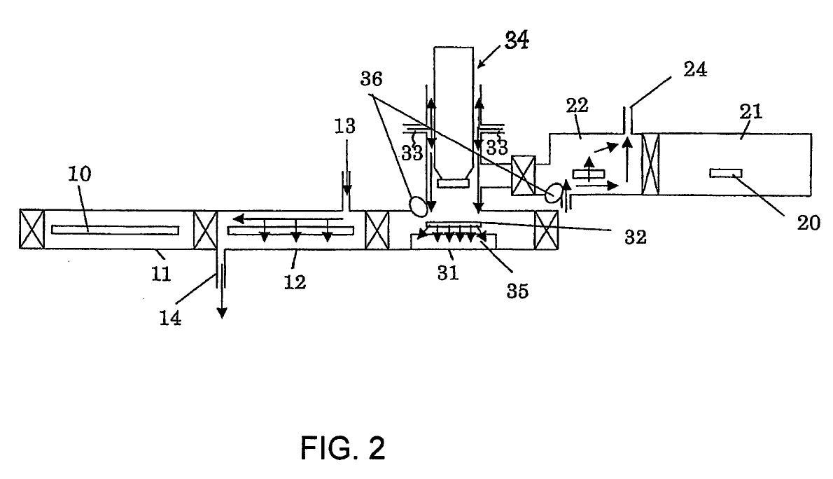

A bonding apparatus in an embodiment of this invention will be described using FIG. 2. FIG. 2 is a schematic diagram showing the structure of the bonding apparatus of this embodiment, wherein a mounting board 10 is introduced from a board introducing chamber 11 and, in a board surface adsorbed water removal chamber 12, a dry inert gas 13 is introduced to remove water.

On the other hand, an element 20 to be mounted on the mounting board 10 is introduced into an element surface adsorbed water removal chamber 22 from an element introducing chamber 21, wherein water on the surface is removed by a dry inert gas. Both are bonded together under pressure in a pressure-bonding chamber 31 having a pressure-bonding arm 34 and a pressure-bonding stage 35.

The bonding apparatus has a non-illustrated board conveying mechanism, a non-illustrated element conveying mechanism, and a non-illustrated board carry-out chamber. The low dew point inert gas 13, 23 is supplied into the board surface adsorbed water removal chamber 12 and the element surface adsorbed water removal chamber 22 to thereby remove the adsorbed water while the board 10 and the element 20 are retained. The supplied low dew point inert gas flows on the surfaces, to be bonded portions, and then is exhausted. Exhaust portions are provided with orifices 14 and 24, respectively, in order to prevent back diffusion of water from the exterior.

In this embodiment, the flow rate of the supply gas 13, 23 was set to 1 liter/min, the passing wind speed through the orifice portion 14, 24 was set to 33 cm/sec, the orifice diameter was set to 8 mm, and the orifice length was set to 10 cm. The inner surface of the apparatus was entirely formed as a chromium-oxide-coated electrolytically polished stainless surface, thereby suppressing adsorption of water. In the pressure-bonding portion, the element 20 can be delivered to the pressure-bonding arm 34 in a dry atmosphere. In the pressure-bonding arm portion, gas flows 33 are formed toward an arm 34 driving portion in order to suppress invasion of water from the arm driving portion. A pressure-bonding portion inert gas introducing mechanism 32 is provided over the pressure-bonding stage 35, thereby thoroughly reducing the amount of water in the pressure-bonding portion. The pressure-bonding portion low dew point inert gas introducing mechanism 32 is in the form of a pipe formed with a number of small holes for gas ejection. The illustrated apparatus is provided with a soft X-ray irradiation apparatus 36 as a mechanism for neutralizing static electricity generated in the apparatus at any of bonding metal terminals, to-be-bonded metal terminals, and the neighborhood therearound or at all of them and thus has a structure for neutralizing the static electricity by soft X-rays from the soft X-ray irradiation apparatus 36.

In this apparatus, the concentration of water over the pressure-bonding stage 35 was measured to be 10 vol.ppb, the amount of adsorbed water on the board and the element was 10¹⁴ molecules/cm², and the amount of adsorbed organic substances thereon was 1×10¹³ molecules/cm² (in terms of eicosane). As a result of formation of bonding by the use of this apparatus, it was possible to form excellent bonding at a temperature of 150° C. lower than the conventional one and at a pressure-bonding pressure of 0.5 t/cm² about half the conventional one.

### INDUSTRIAL APPLICABILITY

A bonding apparatus and a bonding method of this invention are not only effective by applying them to pressure bonding between element terminals and externally leading terminals in a package, but also effective by applying them to pressure bonding when mounting a device package or a bare chip on a mounting board. According to this invention, it is possible to provide a highly reliable electronic device such as a semiconductor device, a flat panel display device, a computer, a portable telephone, a portable information terminal, or a digital video terminal having metal terminals bonded together using the bonding method of this invention.

1. A bonding apparatus for electrically bonding under pressure a bonding metal terminal and a to-be-bonded metal terminal to each other, characterized in that a water concentration in an atmosphere in a pressure-bonding portion is set smaller than that in an atmosphere outside the apparatus.

2. The bonding apparatus according to claim 1, wherein an adsorbed water amount on a surface of the bonding metal terminal and a surface of the to-be-bonded metal terminal in the pressure-bonding portion is 1×10¹⁶ molecules/cm² or less.

3. The bonding apparatus according to claim 1, wherein an adsorbed organic substance amount on a surface of the bonding metal terminal and a surface of the to-be-bonded metal terminal in the pressure-bonding portion is 5×10¹³ molecules/cm² or less in terms of eicosane weight.

4. The bonding apparatus according to claim 1, wherein the water concentration in the atmosphere in the pressure-bonding portion is set to 10 vol.ppm or less.

5. The bonding apparatus according to claim 1, wherein an oxygen concentration in the atmosphere in the pressure-bonding portion is set to 10 vol.ppm or less.

6. The bonding apparatus according to claim 1, wherein an inert gas is circulated to at least the pressure-bonding portion.

7. The bonding apparatus according to claim 1, wherein a high-purity inert gas in which a concentration of impurities excluding water is 100 vol.ppm or less, a water concentration is 10 vol.ppm or less, and an oxygen concentration is 10 vol.ppm or less is circulated to at least the pressure-bonding portion.

8. The bonding apparatus according to claim 7, wherein the water concentration in said inert gas is 1 vol.ppm or less.

9. The bonding apparatus according to claim 1, wherein said bonding apparatus has a supply port for supplying an inert gas from the outside of the apparatus and a water content in said inert gas at said supply port is 10 vol.ppm or less.

10. The bonding apparatus according to claim 1, wherein an adsorbed water amount on an inner surface of said bonding apparatus is 1×10¹⁶ molecules/cm² or less.

11. The bonding apparatus according to claim 1, wherein an inner surface of said apparatus is one of an electrolytically polished stainless surface, an electrochemically polished stainless surface, an electrolytically or electrochemically polished surface containing chromium oxide as a main component, an electrolytically or electrochemically polished surface containing aluminum oxide as a main component, a polyolefin-based resin surface, a polycycloolefin-based resin surface, or a fluorine-based resin surface.

12. The bonding apparatus according to claim 1, comprising means for reducing an adsorbed water amount on a surface of said bonding metal terminal and a surface of said to-be-bonded metal terminal to 1×10¹⁶ molecules/cm² or less.

13. The bonding apparatus according to claim 1, comprising means for reducing an adsorbed organic substance amount on a surface of the bonding metal terminal and a surface of the to-be-bonded metal terminal in the pressure-bonding portion to 5×10¹³ molecules/cm² or less.

14. The bonding apparatus according to claim 6, wherein said inert gas contains at least one of nitrogen, helium, neon, argon, krypton, and xenon.

15. The bonding apparatus according to claim 6, wherein hydrogen is added to said inert gas.

16. The bonding apparatus according to claim 1, comprising means for neutralizing or removing static electricity generated at least one of said bonding metal terminal, said to-be-bonded metal terminal, and a portion around said pressure-bonding portion.

17. The bonding apparatus according to claim 16, wherein said neutralizing or removing means comprises soft X-ray generation means.

18. A bonding method for electrically bonding under pressure a bonding metal terminal and a to-be-bonded metal terminal to each other, comprising a step of setting a water concentration in an atmosphere in a pressure-bonding portion to be smaller than that in an atmosphere outside an apparatus.

19. The bonding method according to claim 18, comprising a step of performing pressure bonding by setting an adsorbed water amount on a surface of the bonding metal terminal and a surface of the to-be-bonded metal terminal in the pressure-bonding portion to be 1×10¹⁶ molecules/cm² or less.

20. The bonding method according to claim 18, comprising a step of performing pressure bonding by setting an adsorbed organic substance amount on a surface of the bonding metal terminal and a surface of the to-be-bonded metal terminal in the pressure-bonding portion to be 5×10¹³ molecules/cm² or less.

21. The bonding method according to claim 18, comprising a step of setting the water concentration in the atmosphere in the pressure-bonding portion to be 10 vol.ppm or less.

22. The bonding method according to claim 18, comprising a step of setting an oxygen concentration in the atmosphere in the pressure-bonding portion to be 10 vol.ppm or less.

23. The bonding method according to claim 18, comprising a step of circulating an inert gas to at least the pressure-bonding portion.

24. The bonding method according to claim 18, comprising a step of circulating a high-purity inert gas in which a concentration of impurities excluding water is 100 vol.ppm or less, a water concentration is 10 vol.ppm or less, and an oxygen concentration is 10 vol.ppm or less, to at least the pressure-bonding portion.

25. The bonding method according to claim 24, comprising a step of setting the water concentration in said inert gas to be 1 vol.ppm or less.

26. The bonding method according to claim 18, comprising a step of performing pressure bonding while shielding said pressure-bonding portion from an external atmosphere, and setting an adsorbed water amount on an inner surface of a shielding portion to be 1×10¹⁶ molecules/cm² or less.

27. The bonding method according to claim 18, comprising a step of performing pressure bonding while shielding said pressure-bonding portion from an external atmosphere, and setting an adsorbed organic substance amount on an inner surface of a shielding portion to be 5×10¹³ molecules/cm² or less.

28. The bonding method according to claim 23, wherein said inert gas contains at least one of nitrogen, helium, neon, argon, krypton, and xenon.

29. The bonding method according to claim 23, comprising a step of adding hydrogen to said inert gas.

30. The bonding method according to claim 18, comprising a step of neutralizing or removing static electricity generated at least one of said bonding metal terminal, said to-be-bonded metal terminal, and a portion around said pressure-bonding portion.

31. The bonding method according to claim 30, comprising a step of neutralizing or removing the static electricity using a soft X-ray.

32. A metal terminal bonding method for electrically bonding under pressure a bonding metal terminal and a to-be-bonded metal terminal to each other, said bonding metal terminal having a surface containing at least one of lead, tin, silver, gold, copper, zinc, aluminum, bismuth, indium, and nickel, and said to-be-bonded metal terminal having a surface containing at least one of lead, tin, silver, gold, copper, zinc, aluminum, bismuth, indium, and nickel, said bonding method comprising a step of forming bonding in a pressure-bonding portion after reducing water adsorbed on surfaces, adapted to form the bonding, to 1×10¹⁶ molecules/cm² or less and reducing an organic substance amount adsorbed on said surfaces to 5×10¹³ molecules/cm² or less.

33. (canceled)

34. A bonding method for electrically bonding under pressure a bonding metal terminal and a to-be-bonded metal terminal to each other, characterized by setting an oxygen concentration in the atmosphere in the pressure-bonding portion to be 10 vol.ppm or less.

35. The bonding method according to claim 34, comprising a step of circulating an inert gas to at least the pressure-bonding portion.

36. The bonding method according to claim 34, comprising a step of performing pressure bonding while shielding said pressure-bonding portion from an external atmosphere, and setting an adsorbed water amount on an inner surface of a shielding portion to be 1×10¹⁶ molecules/cm² or less.

37. The bonding method according to claim 34, comprising a step of performing pressure bonding while shielding said pressure-bonding portion from an external atmosphere, and setting an adsorbed organic substance amount on an inner surface of a shielding portion to be 5×10¹³ molecules/cm² or less.

38. The bonding method according to claim 34, comprising a step of neutralizing or removing static electricity generated at least one of said bonding metal terminal, said to-be-bonded metal terminal, and a portion around said pressure-bonding portion.

39. The bonding method according to claim 34, comprising a step of performing pressure bonding by setting an adsorbed water amount on a surface of the bonding metal terminal and a surface of the to-be-bonded metal terminal in the pressure-bonding portion to be 1×10¹⁶ molecules/cm² or less.

40. The bonding method according to claim 34, wherein pressure bonding is performed by setting an adsorbed organic substance amount on a surface of the bonding metal terminal and a surface of the to-be-bonded metal terminal in the pressure-bonding portion to be 5×10¹³ molecules/cm² or less.

41. An electronic device comprising the metal terminals bonded together using the bonding method according to one of claims 18, 32, or 34.

42. A bonding apparatus for electrically bonding under pressure a bonding metal terminal and a to-be-bonded metal terminal to each other, wherein an oxygen concentration in the atmosphere in the pressure-bonding portion is set to 10 vol.ppm or less.

43. The bonding apparatus according to claim 42, wherein an inert gas is circulated to at least the pressure-bonding portion.

44. The bonding apparatus according to claim 42, wherein an adsorbed water amount on an inner surface of said bonding apparatus is 1×10¹⁶ molecules/cm² or less.

45. The bonding apparatus according to claim 42, wherein an inner surface of said apparatus is one of an electrolytically polished stainless surface, an electrochemically polished stainless surface, an electrolytically or electrochemically polished surface containing chromium oxide as a main component, an electrolytically or electrochemically polished surface containing aluminum oxide as a main component, a polyolefin-based resin surface, a polycycloolefin-based resin surface, or a fluorine-based resin surface.

46. The bonding apparatus according to claim 42, comprising means for reducing an adsorbed water amount on a surface of said bonding metal terminal and a surface of said to-be-bonded metal terminal to 1×10¹⁶ molecules/cm² or less.

47. The bonding apparatus according to claim 42, comprising means for reducing an adsorbed organic substance amount on a surface of the bonding metal terminal and a surface of the to-be-bonded metal terminal in the pressure-bonding portion to 5×10¹³ molecules/cm² or less.

48. The bonding apparatus according to claim 42, comprising means for neutralizing or removing static electricity generated at least one of said bonding metal terminal, said to-be-bonded metal terminal, and a portion around said pressure-bonding portion.
